(19) United States
(12) Patent Application Publication
(10) Pub. No.: US 2022/0003560 A1
(43) Pub. Date: Jan. 6, 2022

(54) ELECTRONIC DEVICE FOR VEHICLE, AND METHOD AND SYSTEM FOR OPERATING ELECTRONIC DEVICE FOR VEHICLE

(71) Applicant: LG Electronics Inc., Seoul (KR)

(72) Inventor: Jinsang LEE, Seoul (KR)

(21) Appl. No.: 17/260,518

(22) PCT Filed: Mar. 22, 2019
(86) PCT No.: PCT/KR2019/003357

§ 371 Date: Jan. 14, 2021

(51) Int. Cl. G01C 21/34; G01C 21/00; G01C 21/36

(52) U.S. Cl. CPC G01C 21/3407; G01C 21/3691; G01C 21/3889

(57) ABSTRACT

An electronic device included in a leader vehicle among a plurality of platooning vehicles includes a power supply configured to supply power, an interface configured to receive high-definition (HD) map data of a specified region from a server through a communication device, and a processor configured to continuously generate electronic horizon data of the specified region based on the HD map data in a state in which the power is received, to calculate a range of a group based on information on a position of a following vehicle among the plurality of vehicles, and to generate electronic horizon data for platooning based on the range of the group.

### TECHNICAL FIELD

The present disclosure relates to an electronic device for a vehicle, and a method and system for operating an electronic device for a vehicle.

### BACKGROUND ART

A vehicle refers to a device that carries a passenger in a direction intended by a passenger. A car is a major example of such a vehicle. In the industrial field of vehicles, application of an advanced driver assistance system (ADAS) is under active study to increase the driving convenience of users. Furthermore, the application of autonomous driving of vehicles is also under active study.

The application of ADAS or the application of autonomous driving may be configured based on map data. Conventionally, low-scale standard definition (SD) map data is provided to users while being stored in a memory installed in a vehicle. However, recently, as the need for high-scale high-definition (HD) map data has increased, map data into which a cloud service is integrated has come to be provided to users.

Platooning into which autonomous driving technology is integrated is required to generate data related to autonomous driving using a different method from a single vehicle due to the size of a group. Platooning has a problem in that communication load and data processing load are generally increased when all vehicles belonging to a group receive HD map data.

### DISCLOSURE

### Technical Problem

To overcome the aforementioned problems, the present disclosure may provide an electronic device for generating electronic horizon data by relatively effectively processing data in a leader vehicle in the case of platooning.

The present disclosure may provide an electronic device for generating electronic horizon data by relatively effectively processing data in a following vehicle.

The present disclosure may provide a system for generating electronic horizon data by relatively effectively processing data in an infrastructure.

It will be appreciated by persons skilled in the art that that the effects that could be achieved with the present disclosure are not limited to what has been particularly described hereinabove and other advantages of the present disclosure will be more clearly understood from the detailed description.

### Technical Solution

In accordance with the present disclosure, the above and other objects can be accomplished by the provision of an electronic device included in a leader vehicle among a plurality of platooning vehicles, including a power supply configured to supply power, an interface configured to receive high-definition (HD) map data of a specified region from a server through a communication device, and a processor configured to continuously generate electronic horizon data of the specified region based on the HD map data in a state in which the power is received, to calculate a range of a group based on information on a position of a following vehicle among the plurality of vehicles, and to generate electronic horizon data for platooning based on the range of the group.

The processor may transmit the HD map data and the electronic horizon data to at least one of following vehicles when the group is supposed to be divided, and the electronic horizon data may include information on a point at which the group is divided and information on a point at which a vehicle joins the group.

The processor may transmit a signal for requesting electronic horizon data to a first following vehicle based on computing power.

When determining that the first following vehicle deviates from the group, the processor may transmit a signal for requesting electronic horizon data to a second following vehicle having the lowest power consumption among vehicles of the group.

When determining that arrangement of the group is changed, the processor may calculate a range of the changed group, and may manipulate the electronic horizon data based on the range of the changed group.

The processor may generate main path data with respect to a road on which the group is capable of passing as a target, based on the range of the group.

The processor may delete the main path data based on information on a position of a last following vehicle.

The processor may determine a sensing region required to generate a horizon path based on information on the leader vehicle and information on the following vehicle.

The processor may receive information on a destination of the following vehicle, and may generate sub path data of a branch road at which the following vehicle deviates from the group based on the information on the destination.

The processor may acquire information on a traffic light, and may manipulate the electronic horizon data based on the information on the traffic light and information on the group.

The processor may determine a traveling lane in further consideration of information on a traveling speed for each lane, information on whether a current lane is a platooning lane, and information on a branch point.

According to an embodiment of the present disclosure, an electronic device included in a leader vehicle among a plurality of platooning vehicles includes a power supply configured to supply power, an interface configured to receive high-definition (HD) map data of a specified region from a server through a communication device, and a processor configured to continuously generate electronic horizon data of the specified region based on the HD map data in a state in which the power is received, and to generate electronic horizon data for platooning and to provide the electronic horizon data to the leader vehicle and another following vehicle when receiving a signal for requesting data processing from a leader vehicle among the plurality of vehicles.

According to an embodiment of the present disclosure, a system includes a leader vehicle, at least one following vehicle configured to follow the leader vehicle while configuring a group, and an infrastructure configured to communicate with the leader vehicle and the following vehicle, wherein the infrastructure receives information on a range of a group from at least one of the leader vehicle or the following vehicle, generates electronic horizon data for platooning based on the range of the group, and provides the electronic horizon data to the leader vehicle and the following vehicle.

The infrastructure may receive information on a changed situation of the group from at least one of the leader vehicle or the following vehicle, and may manipulate the electronic horizon data based on the information on the changed situation of the group.

The leader vehicle may backup the electronic horizon data.

Details of other embodiments are included in detailed descriptions and drawings.

### Advantageous Effects

As is apparent from the foregoing description, the embodiments of the present disclosure have the following one or more effects.

First, in the case of platooning, communication load and data processing load may be reduced via effective communication and data processing.

Second, a plurality of vehicles constituting a group may share electronic horizon data, and thus platooning may be possible irrespective of a communication state between vehicles.

It will be appreciated by persons skilled in the art that that the effects that could be achieved with the present disclosure are not limited to what has been particularly described hereinabove and other advantages of the present disclosure will be more clearly understood from the following claims.

### DESCRIPTION OF DRAWINGS

FIG. 1 is a diagram showing a vehicle that travels on a road according to an embodiment of the present disclosure.

FIG. 2 is a diagram for explaining a system according to an embodiment of the present disclosure.

FIG. 3 is a diagram for explaining a vehicle including an electronic device according to an embodiment of the present disclosure.

FIG. 4 is diagram showing an example of the outer appearance of an electronic device according to an embodiment of the present disclosure.

FIGS. 5A to 5C are flowcharts of a signal inside a vehicle including an electronic device according to an embodiment of the present disclosure.

FIGS. 6A and 6B are diagrams for explaining an operation of receiving high-definition (HD) map data according to an embodiment of the present disclosure.

FIG. 6C is a diagram for explaining an operation of generating electronic horizon data according to an embodiment of the present disclosure.

FIG. 7 is a diagram for explaining platooning according to an embodiment of the present disclosure.

FIG. 8 is a flowchart of an electronic device according to an embodiment of the present disclosure.

FIGS. 9 to 11B are diagrams for explaining an operation of an electronic device according to an embodiment of the present disclosure.

### BEST MODE

Reference will now be made in detail to exemplary embodiments of the present disclosure, examples of which are illustrated in the accompanying drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purposes of clarity and brevity. The features of the present disclosure will be more clearly understood from the accompanying drawings, and should not be understood to be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, “third” etc. may be used herein to describe various elements, these elements should not be limited by these terms. These terms are only used to distinguish one element from another element.

It will be understood that when an element is referred to as being “on”, “connected to” or “coupled to” another element, it may be directly on, connected to or coupled to the other element, or intervening elements may be present. In contrast, when an element is referred to as being “directly on,” “directly connected to” or “directly coupled to” another element or layer, there are no intervening elements present.

Singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

In the description below, the left side of the vehicle means the left side with respect to the travel direction of the vehicle and the right side of the vehicle means the right side with respect to the travel direction of the vehicle.

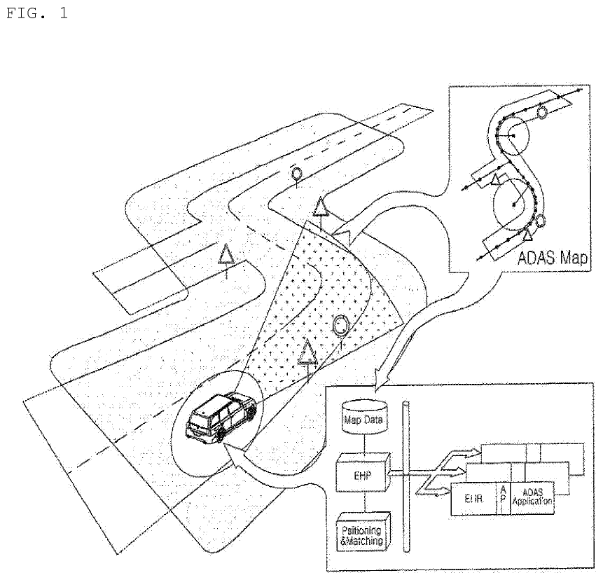

FIG. 1 is a diagram showing a vehicle that travels on a road according to an embodiment of the present disclosure.

Referring to FIG. 1, a vehicle 10 according to an embodiment may be defined as a form of a transport that travels on a road or rails. The vehicle 10 may be interpreted as including an automobile, a train, or a motorcycle. Hereinafter, an autonomous driving vehicle that travels without driver manipulation for driving or a vehicle including an advanced driver assistance system (ADAS) will exemplify the vehicle 10.

The vehicle described in this specification may include a vehicle equipped with an internal combustion engine as a power source, a hybrid vehicle equipped with both an engine and an electric motor as a power source, and an electric vehicle equipped with an electric motor as a power source.

The vehicle 10 may include an electronic device 100. The electronic device 100 may be referred to as an electronic horizon provider (EHP). The electronic device 100 may be conductively connected to another electronic device inside the vehicle 10 in the state of being installed in the vehicle 10.

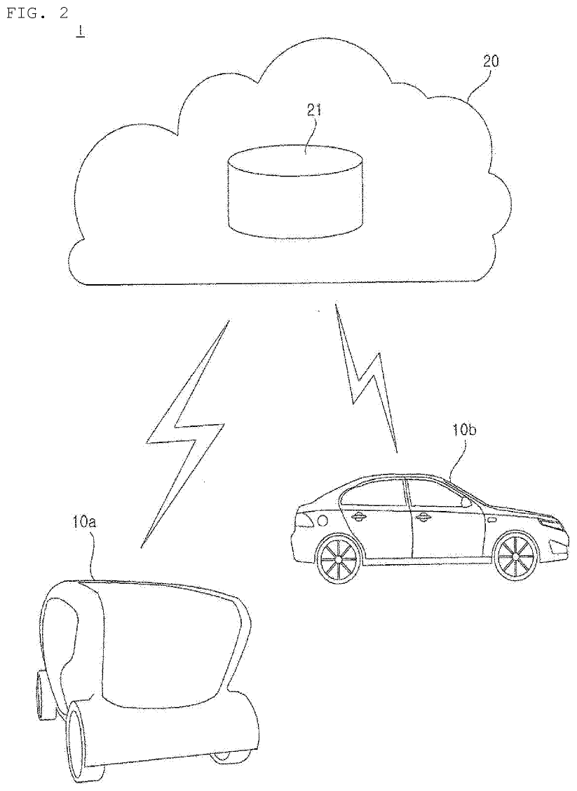

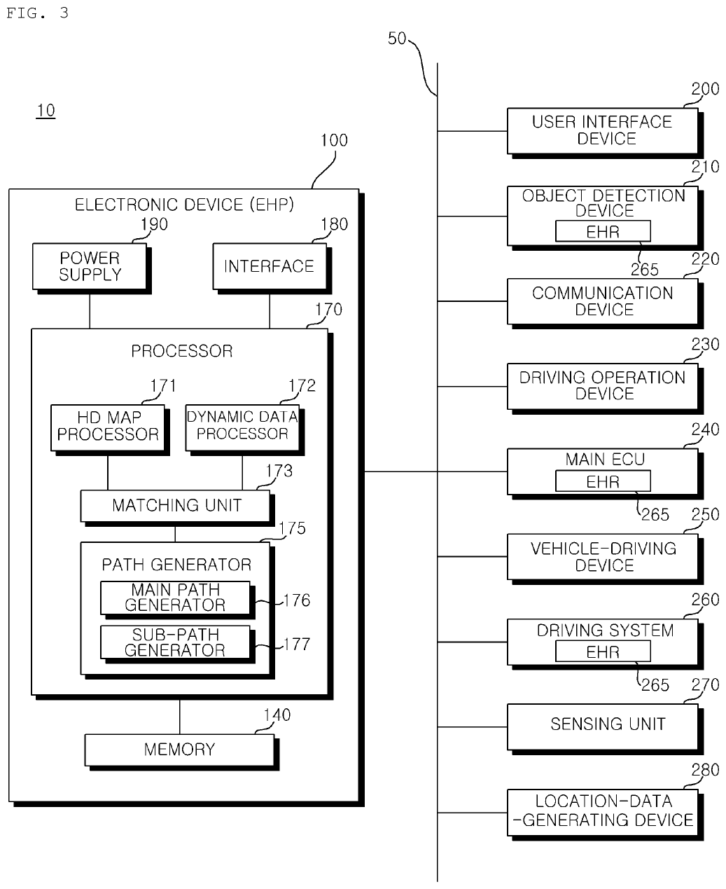

FIG. 2 is a diagram for explaining a system according to an embodiment of the present disclosure.

Referring to FIG. 2, a system 1 may include an infrastructure 20 and at least one vehicle 10a and 10b.

The infrastructure 20 may include at least one server 21. The server 21 may receive data generated by the vehicles 10a and 10b. The server 21 may process the received data. The server 21 may manipulate the received data.

The server 21 may receive data generated by at least one electronic device installed in the vehicles 10a and 10b. For example, the server 21 may receive data generated by at least one of an EHP, a user interface device, an object detection device, a communication device, a driving manipulation device, a main ECU, a vehicle-driving device, a travel system, a sensor, and a position-data-generating-device. The server 21 may generate big data based on the data received from a plurality of vehicles. For example, the server 21 may receive dynamic data from the vehicles 10a and 10b and may generate big data based on the received dynamic data. The server 21 may update HD map data based on the data received from a plurality of vehicles. For example, the server 21 may receive data generated by an object detection device from the EHP included in the vehicles 10a and 10b and may update HD map data.

The server 21 may provide pre-stored data to the vehicles 10a and 10b. For example, the server 21 may provide at least one of high-definition (HD) map data or standard definition (SD) map data to the vehicles 10a and 10b. The server 21 may classify the map data into map data for respective sections, and may provide only the map data corresponding to a section requested by the vehicles 10a and 10b. The HD map data may be referred to as high-precision map data.

The server 21 may provide data that is processed or manipulated by the server 21 to the vehicles 10a and 10b. The vehicles 10a and 10b may generate a travel control signal based on data received from the server 21. For example, the server 21 may provide the HD map data to the vehicles 10a and 10b. For example, the server 21 may provide dynamic data to the vehicles 10a and 10b.

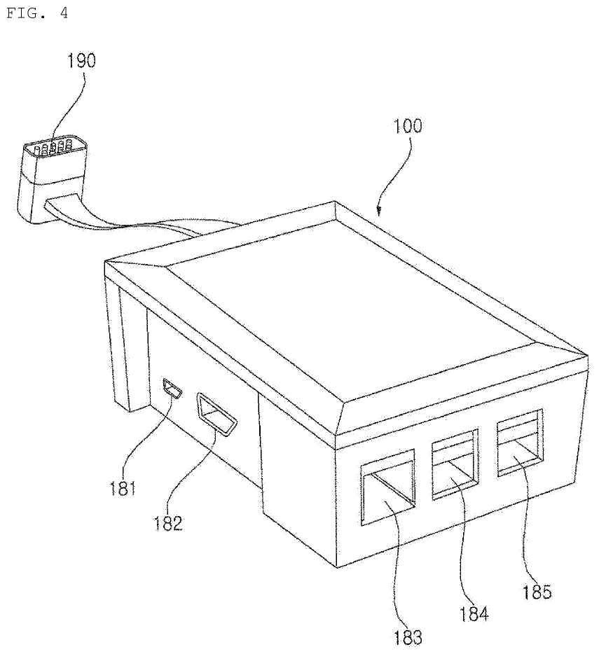

FIG. 3 is a diagram for explaining a vehicle including an electronic device according to an embodiment of the present disclosure.

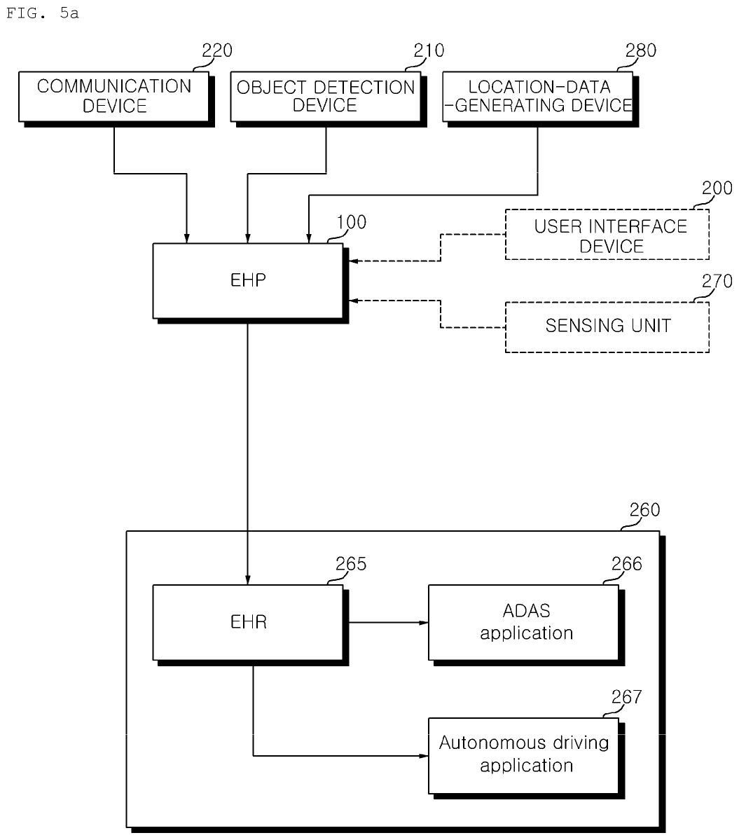

FIG. 4 is diagram showing an example of the outer appearance of an electronic device according to an embodiment of the present disclosure.

Referring to FIGS. 3 and 4, the vehicle 10 may include the electronic device 100, a user interface device 200, an object detection device 210, a communication device 220, a driving manipulation device 230, a main electronic control unit (ECU) 240, a vehicle-driving device 250, a travel system 260, a sensor 270, and a position-data-generating-device 280.

The electronic device 100 may be referred to as an electronic horizon provider (EHP). The electronic device 100 may generate electronic horizon data and may provide the same to at least one electronic device included in the vehicle 10.

The electronic horizon data may be described as driving plan data used to generate a travel control signal of the vehicle 10 in the travel system 260. For example, the electronic horizon data may be understood as driving plan data within a range to a horizon from the point where the vehicle 10 is positioned. Here, the horizon may be understood as a point a preset distance ahead of the point at which the vehicle 10 is positioned based on a preset travel path. The horizon may refer to a point that the vehicle 10 is capable of reaching after a predetermined time from the point at which the vehicle is positioned along the preset traveling path. Here, the travel path may refer to a travel path to a final destination, and may be set by user input.

The electronic horizon data may include horizon map data and horizon path data.

The horizon map data may include at least one of topology data, ADAS data, HD map data, or dynamic data. In some embodiments, the horizon map data may include a plurality of layers. For example, the horizon map data may include a first layer matching the topology data, a second layer matching the ADAS data, a third layer matching the HD map data, and a fourth layer matching the dynamic data. The horizon map data may further include static object data.

The topology data may be described as a map made by connecting middle parts of roads. The topology data may be appropriate to broadly indicate the position of a vehicle and may be configured in the form of data that is mainly used in a navigation device for a driver. The topology data may be understood as data about road information other than information on lanes. The topology data may be generated based on data received from the infrastructure 20. The topology data may be based on data generated by the infrastructure 20. The topology data may be based on data stored in at least one memory included in the vehicle 10.

The ADAS data may refer to data related to information on a road. The ADAS data may include at least one of data on a slope of a road, data on a curvature of a road, or data on a speed limit of a road. The ADAS data may further include data on a no-passing zone. The ADAS data may be based on data generated by the infrastructure 20. The ADAS data may be based on data generated by the object detection device 210. The ADAS data may be referred to as road information data.

The HD map data may include topology information in units of detailed lanes of a road, information on connection between lanes, and information on characteristics for localization of a vehicle (e.g., a traffic sign, lane marking/attributes, or road furniture). The HD map data may be based on data generated by the infrastructure 20.

The dynamic data may include various pieces of dynamic information to be generated on a road. For example, the dynamic data may include information on construction, information on variable-speed lanes, information on the state of a road surface, information on traffic, and information on moving objects. The dynamic data may be based on data received from the infrastructure 20. The dynamic data may be based on data generated by the object detection device 210.

The electronic device 100 may provide map data within a range to a horizon from the point where the vehicle 10 is positioned.

The horizon path data may be described as the trajectory of the vehicle 10 within a range to a horizon from the point where the vehicle 10 is positioned. The horizon path data may include data indicating the relative probability of selection of any one among roads at a decision point (e.g., a forked road, a junction, or an intersection). The relative probability may be calculated based on the time taken to reach a final destination. For example, when a first road is selected at the decision point, if the time taken to reach a final destination is shorter than in the case in which a second road is selected, the probability of selecting the first road may be calculated to be higher than the probability of selecting the second road.

The horizon path data may include a main path and a sub path. The main path may be understood as a trajectory formed by connecting roads having a high probability of being selected. The sub path may branch from at least one decision point on the main path. The sub path may be understood as a trajectory formed by connecting roads having a low probability of being selected from at least one decision point on the main path.

The electronic device 100 may include an interface 180, a power supply 190, a memory 140, and a processor 170.

The interface 180 may exchange a signal with at least one electronic device included in the vehicle 10 in a wired or wireless manner. The interface 180 may exchange a signal with at least one of the user interface device 200, the object detection device 210, the communication device 220, the driving manipulation device 230, the main ECU 240, the vehicle-driving device 250, the travel system 260, the sensor 270, or the position-data-generating-device 280 in a wired or wireless manner. The interface 180 may include at least one of a communication module, a terminal, a pin, a cable, a port, a circuit, an element, or a device.

The power supply 190 may supply power to the electronic device 100. The power supply 190 may receive power from a power source (e.g., a battery) included in the vehicle 10 and may provide power to each unit of the electronic device 100. The power supply 190 may operate according to a control signal provided from the main ECU 240. The power supply 190 may be embodied as a switched-mode power supply (SMPS).

The memory 140 is conductively connected to the controller 170. The memory 140 may store default data for a unit, control data for controlling the operation of the unit, and input and output data. The memory 140 may be any of various storage devices in hardware, such as read only memory (ROM), random access memory (RAM), erasable and programmable ROM (EPROM), flash drive, and hard drive. The memory 140 may store various data for the overall operation of the vehicle 100, such as programs for processing or controlling in the controller 170.

The processor 170 may be conductively connected to the interface 180 and the power supply 190 and may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions.

The processor 170 may be driven by power provided from the power supply 190. The processor 170 may continuously generate electronic horizon data in the state in which the power supply 190 supplies power.

The processor 170 may generate electronic horizon data. The processor 170 may generate electronic horizon data. The processor 170 may generate horizon path data.

The processor 170 may generate electronic horizon data by applying a traveling situation of the vehicle 10. For example, the processor 170 may generate the electronic horizon data based on traveling direction data and traveling speed data of the vehicle 10.

The processor 170 may combine the generated electronic horizon data with the pre-generated electronic horizon data. For example, the processor 170 may connect horizon map data generated at a first time with horizon map data generated at a second time in terms of position. For example, the processor 170 may connect horizon path data generated at a first time with horizon path data generated at a second time in terms of position.

The processor 170 may provide electronic horizon data. The processor 170 may provide the electronic horizon data to at least one of the travel system 260 or the main ECU 240 through the interface 180.

The processor 170 may include the memory 140, an HD map processor 171, a dynamic data processor 172, a matcher 173, and a path generator 175.

The HD map processor 171 may receive HD map data from the server 21 through the communication device 220. The HD map processor 171 may store the HD map data. In some embodiments, the HD map processor 171 may process and manipulate the HD map data.

The dynamic data processor 172 may receive dynamic data from the object detection device 210. The dynamic data processor 172 may receive the dynamic data from the server 21. The dynamic data processor 172 may store the dynamic data. In some embodiments, the dynamic data processor 172 may process and manipulate the dynamic data.

The matcher 173 may receive an HD map from the HD map processor 171. The matcher 173 may receive the dynamic data from the dynamic data processor 172. The matcher 173 may generate horizon map data by matching the HD map data and the dynamic data.

In some embodiments, the matcher 173 may receive topology data. The matcher 173 may receive ADAS data. The matcher 173 may generate horizon map data by matching topology data, ADAS data, HD map data, and dynamic data.

The path generator 175 may generate horizon path data. The path generator 175 may include a main path generator 176 and a sub path generator 177. The main path generator 176 may generate main path data. The sub path generator 177 may generate sub path data.

The electronic device 100 may include at least one printed circuit board (PCB). The interface 180, the power supply 190, and the processor 170 may be conductively connected to the PCB.

In some embodiments, the electronic device 100 may be integrated into the communication device 220. In this case, the vehicle 10 may include the communication device 220 as a lower-ranking component of the electronic device 100.

The user interface device 200 may be a device for communication between the vehicle 10 and a user. The user interface device 200 may receive user input and may provide information generated by the vehicle 10 to a user. The vehicle 10 may embody a user interface (UI) or user experience (UX) through the user interface device 200.

The object detection device 210 may detect an object outside the vehicle 10. The object detection device 210 may include at least one of a camera, a RADAR, a LiDAR, an ultrasonic sensor, or an infrared sensor. The object detection device 210 may provide data on an object, generated based on a sensing signal generated by a sensor, to at least one electronic device included in a vehicle.

The object detection device 210 may generate dynamic data based on a sensing signal for sensing an object. The object detection device 210 may provide the dynamic data to the electronic device 100.

The object detection device 210 may receive electronic horizon data. The object detection device 210 may include an electronic horizon re-constructor (EHR) 265. The EHR 265 may convert the electronic horizon data into the data format to be used in the object detection device 210.

The communication device 220 may exchange a signal with a device positioned outside the vehicle 10. The communication device 220 may exchange a signal with at least one of an infrastructure (e.g., a server) or other vehicles. The communication device 220 may include at least one of a transmission antenna and a reception antenna for communication, and a radio frequency (RF) circuit or an RF device for embodying various communication protocols.

The driving manipulation device 230 may be a device for receiving user input for driving. In the case of a manual mode, the vehicle 10 may be driven based on a signal provided by the driving manipulation device 230. The driving manipulation device 230 may include a steering input device (e.g., a steering wheel), an acceleration input device (e.g., an accelerator pedal), and a brake input device (e.g., a brake pedal).

The main ECU 240 may control the overall operation of at least one electronic device included in the vehicle 10.

The main ECU 240 may receive electronic horizon data. The main ECU 240 may include an electronic horizon re-constructor (EHR) 265. The EHR 265 may convert the electronic horizon data into a data format to be used in the main ECU 240.

The vehicle-driving device 250 may be a device for electrical control of various devices in the vehicle 10. The vehicle-driving device 250 may include a powertrain driver, a chassis driver, a door/window driver, a safety device driver, a lamp driver, and a conditioning driver. The powertrain driver may include a power source driver and a transmission driver. The chassis driver may include a steering driver, a brake driver, and a suspension driver.

The travel system 260 may perform a traveling operation of the vehicle 10. The travel system 260 may provide a control signal to at least one of a powertrain driver or a chassis driver of the vehicle-driving device 250, and may move the vehicle 10.

The travel system 260 may receive electronic horizon data. The travel system 260 may include an electronic horizon re-constructor (EHR) 265. The EHR 265 may convert the electronic horizon data into a data format to be used in an ADAS application and an autonomous driving application.

The travel system 260 may include at least one of an ADAS application or an autonomous driving application. The travel system 260 may generate a travel control signal using at least one of the ADAS application and the autonomous driving application.

The sensor 270 may sense the state of a vehicle. The sensor 270 may include at least one of an inertial navigation unit (IMU) sensor, a collision sensor, a wheel sensor, a speed sensor, an inclination sensor, a weight detection sensor, a heading sensor, a position module, a vehicle forward/backward sensor, a battery sensor, a fuel sensor, a tire sensor, a steering sensor using rotation of a steering wheel, a vehicle interior temperature sensor, a vehicle interior humidity sensor, an ultrasonic sensor, an illumination sensor, an accelerator pedal position sensor, or a brake pedal position sensor. The inertial navigation unit (IMU) sensor may include one or more of an acceleration sensor, a gyro sensor, and a magnetic sensor.

The sensor 270 may generate data on the state of the vehicle based on a signal generated by at least one sensor. The sensor 270 may acquire a sensing signal for sensing vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward information, battery information, fuel information, tire information, vehicle lamp information, vehicle interior temperature information, vehicle interior humidity information, steering wheel rotation angle, vehicle external illumination, the pressure applied to an accelerator pedal, the pressure applied to a brake pedal, and the like.

In addition, the sensor 270 may further include an accelerator pedal sensor, a pressure sensor, an engine rotation speed sensor, an air flow sensor (AFS), an air temperature sensor (ATS), a water temperature sensor (WTS), a throttle position sensor (TPS), a TDC sensor, and a crank angle sensor (CAS).

The sensor 270 may generate vehicle state information based on sensing data. The vehicle state information may be information generated based on data detected by various sensors included in a vehicle.

For example, the vehicle state information may include vehicle posture information, vehicle speed information, vehicle inclination information, vehicle weight information, vehicle direction information, vehicle battery information, vehicle fuel information, vehicle tire air-pressure information, vehicle steering information, vehicle interior temperature information, vehicle interior humidity information, pedal position information, and vehicle engine temperature information.

The position-data-generating-device 280 may generate position data of the vehicle 10. The position-data-generating-device 280 may include at least one of a global positioning system (GPS) or a differential global positioning system (DGPS). The position-data-generating-device 280 may generate position data of the vehicle 10 based on a signal generated by at least one of the GPS or the DGPS. In some embodiments, the position-data-generating-device 280 may correct the position data based on at least one of an inertial measurement unit (IMU) of the sensor 270 or a camera of the object detection device 210.

The vehicle 10 may include an internal communication system 50. A plurality of electronic devices included in the vehicle 10 may exchange a signal using the internal communication system 50 as a medium. The signal may include data. The internal communication system 50 may use at least one communication protocol (e.g., CAN, LIN, FlexRay, MOST, or Ethernet).

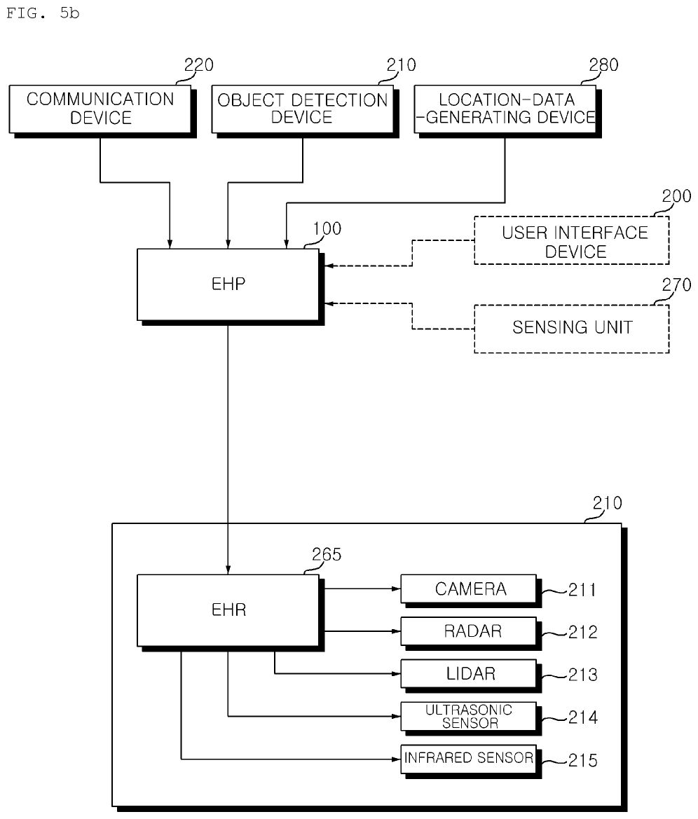

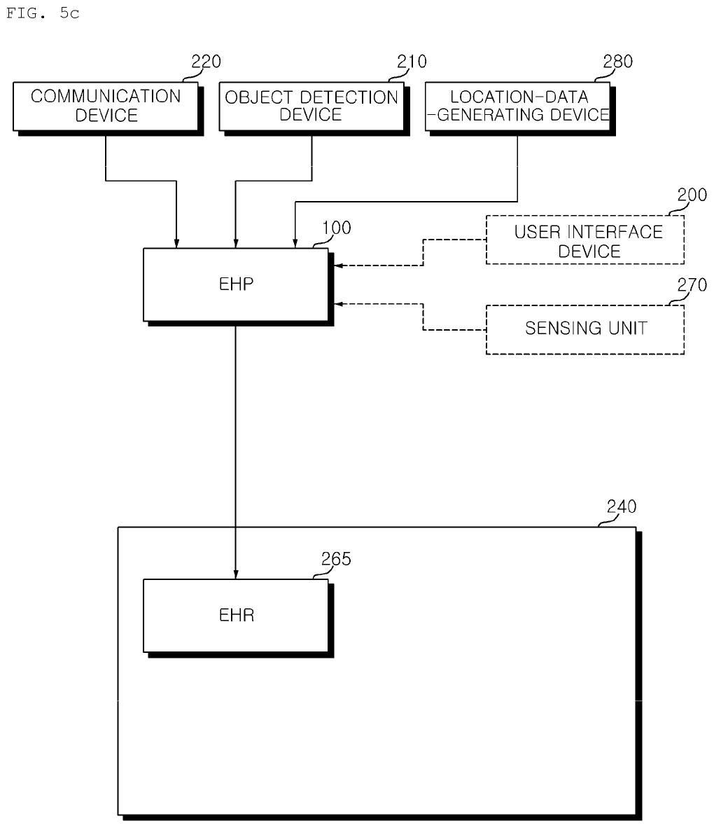

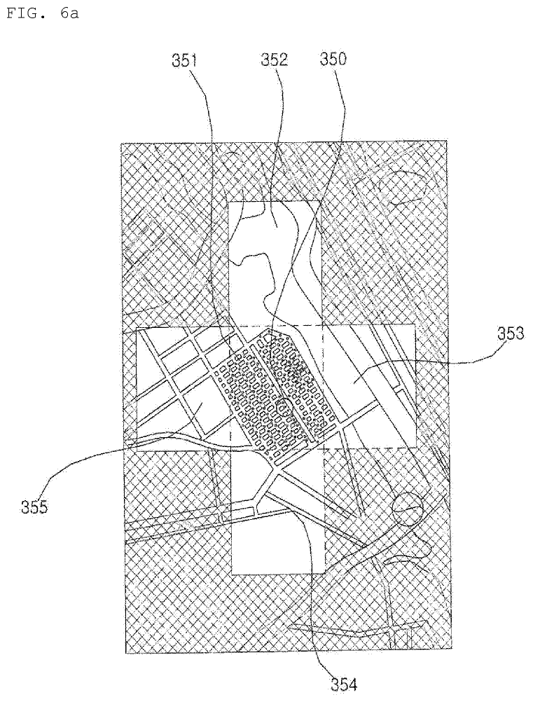

FIG. 5A is a flowchart of a signal inside a vehicle including an electronic device according to an embodiment of the present disclosure.

Referring to FIG. 5A, the electronic device 100 may receive HD map data from the server 21 through the communication device 220.

The electronic device 100 may receive dynamic data from the object detection device 210. In some embodiments, the electronic device 100 may also receive dynamic data from the server 21 through the communication device 220.

The electronic device 100 may receive position data of a vehicle from the position-data-generating-device 280.

In some embodiments, the electronic device 100 may receive a signal based on user input through the user interface device 200. In some embodiments, the electronic device 100 may receive vehicle state information from the sensor 270.

The electronic device 100 may generate electronic horizon data based on HD map data, dynamic data, and position data. The electronic device 100 may match the HD map data, the dynamic data, and the position data with each other to generate horizon map data. The electronic device 100 may generate horizon path data on a horizon map. The electronic device 100 may generate main path data and sub path data on the horizon map.

The electronic device 100 may provide electronic horizon data to the travel system 260. The EHR 265 of the travel system 260 may convert the electronic horizon data into a data format appropriate for applications 266 and 267. The applications 266 and 267 may generate a travel control signal based on the electronic horizon data. The travel system 260 may provide the travel control signal to the vehicle-driving device 250.

The travel system 260 may include at least one of an ADAS application 266 or an autonomous driving application 267. The ADAS application 266 may generate a control signal for assisting the driver in driving of the vehicle 10 through the driving manipulation device 230 based on the electronic horizon data. The autonomous driving application 267 may generate a control signal for moving the vehicle 10 based on the electronic horizon data.

FIG. 5B is a flowchart of a signal inside a vehicle including an electronic device according to an embodiment of the present disclosure.

With reference to FIG. 5B, the embodiment of the present disclosure will be described in terms of differences from FIG. 5A. The electronic device 100 may provide the electronic horizon data to the object detection device 210. The EHR 265 of the object detection device 210 may convert the electronic horizon data into a data format appropriate for the object detection device 210. The object detection device 210 may include at least one of a camera 211, a RADAR 212, a LiDAR 213, an ultrasonic sensor 214, or an infrared sensor 215. The electronic horizon data, the data format of which is converted by the EHR 265, may be provided to at least one of the camera 211, the RADAR 212, the LiDAR 213, the ultrasonic sensor 214, or the infrared sensor 215. At least one of the camera 211, the RADAR 212, the LiDAR 213, the ultrasonic sensor 214, or the infrared sensor 215 may generate data based on the electronic horizon data.

FIG. 5C is a flowchart of a signal inside a vehicle including an electronic device according to an embodiment of the present disclosure.

With reference to FIG. 5C, the embodiment of the present disclosure will be described in terms of differences from FIG. 5A. The electronic device 100 may provide electronic horizon data to the main ECU 240. The EHR 265 of the main ECU 240 may convert the electronic horizon data into a data format appropriate for the main ECU 240. The main ECU 240 may generate a control signal based on the electronic horizon data. For example, the main ECU 240 may generate a control signal for controlling at least one of the user interface device 180, the object detection device 210, the communication device 220, the driving manipulation device 230, the vehicle-driving device 250, the travel system 260, the sensor 270, or the position-data-generating-device 280 based on the electronic horizon data.

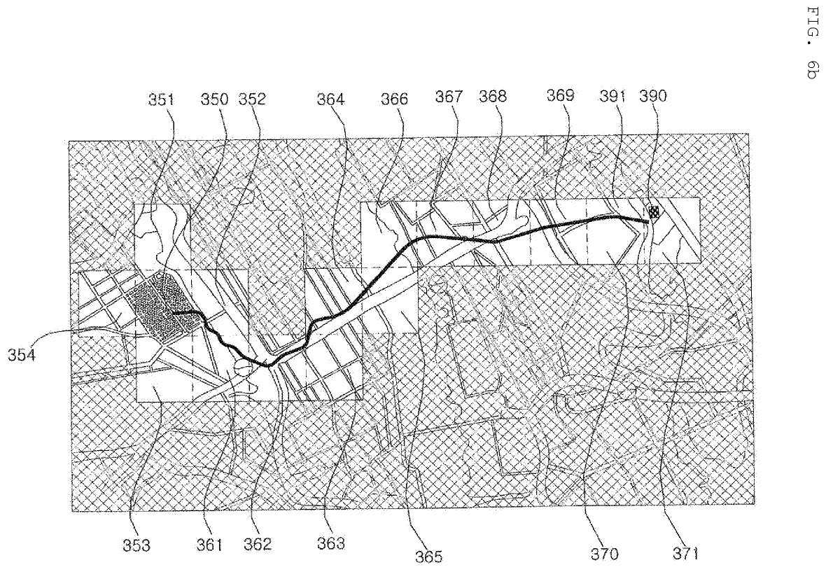

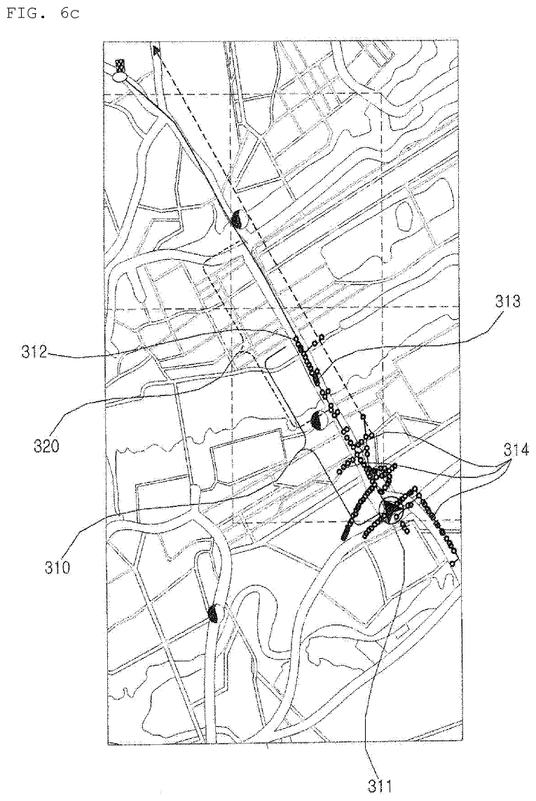

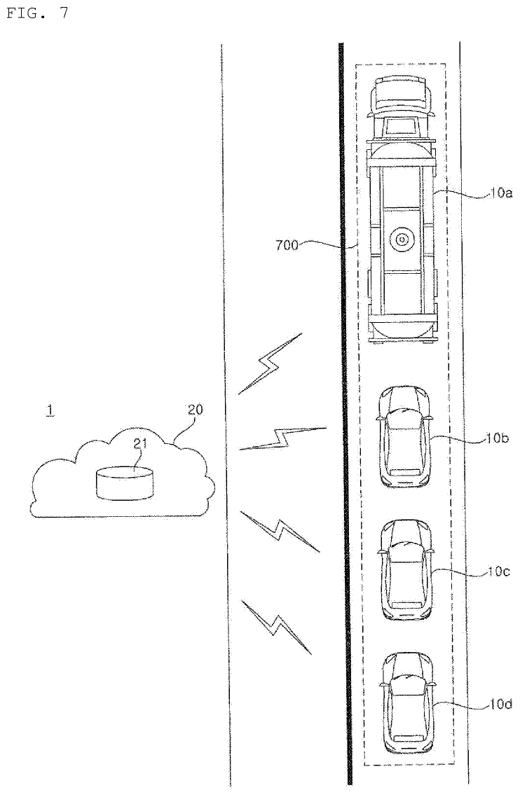

FIGS. 6A and 6B are diagrams for explaining an operation of receiving HD map data according to an embodiment of the present disclosure.

The server 21 may divide the HD map data in units of HD map tiles and may provide the divided HD map data to the electronic device 100. The processor 170 may download the HD map data in units of HD map tiles from the server 21 through the communication device 220.

An HD map tile may be defined as sub HD map data obtained by geographically dividing an entire HD map into rectangular shapes. All HD map data may be acquired by connecting all HD map tiles. The HD map data is high-scale data, and thus the vehicle 10 requires a high-performance controller to download all of the HD map data and to use the downloaded HD map data by the vehicle 10. As communication technologies have been developed, the vehicle 10 may download and use the HD map data in the form of HD map tiles and may thus obviate a high-performance controller rather than requiring inclusion of the high-performance controller, and thus may effectively process data.

The processor 170 may store the downloaded HD map tile in the memory 140. The processor 170 may delete the stored HD map tile. For example, the processor 170 may delete the HD map tile when the vehicle 10 moves out of a section corresponding to the HD map tile. For example, the processor 170 may delete the HD map tile when a preset time elapses since the HD map tile was stored.

FIG. 6A is a diagram for explaining an operation of receiving HD map data when there is no preset destination.

Referring to FIG. 6A, when there is no preset destination, the processor 170 may receive a first HD map tile 351 including a position 350 of the vehicle 10. The server 21 may receive data on the position 350 of the vehicle 10 from the vehicle 10 and may provide the first HD map tile 351 including a position 250 of the vehicle 10 to the vehicle 10. The processor 170 may receive HD map tiles 352, 353, 354, and 355 around the first HD map tile 351. For example, the processor 170 may receive the HD map tiles 352, 353, 354, and 355 that neighbor upper, lower, left, and right sides of the first HD map tile 351, respectively. In this case, the processor 170 may receive five HD map tiles in total. For example, the processor 170 may further receive an HD map tile positioned in a diagonal direction from the first HD map tile 351 along with the HD map tiles 352, 353, 354, and 355 that neighbor upper, lower, left, and right sides of the first HD map tile 351, respectively. In this case, the processor 170 may receive nine HD map tiles in total.

FIG. 6B is a diagram for explaining an operation of receiving HD map data when there is a preset destination.

Referring to FIG. 6B, when there is a preset destination, the processor 170 may receive tiles 350, 352, 361, 362, 363, 364, 365, 366, 367, 368, 369, 370, and 371 associated with a path 391 to the position 350 of the vehicle 10. The processor 170 may receive the plurality of tiles 350, 352, 361, 362, 363, 364, 365, 366, 367, 368, 369, 370, and 371 to cover the path 391.

The processor 170 may receive all of the tiles 350, 352, 361, 362, 363, 364, 365, 366, 367, 368, 369, 370, and 371, which cover the path 391, at one time.

While the vehicle 10 moves along the path 391, the processor 170 may separately receive all of the tiles 350, 352, 361, 362, 363, 364, 365, 366, 367, 368, 369, 370, and 371. While the vehicle 10 moves along the path 391, the processor 170 may receive only at least some of the tiles 350, 352, 361, 362, 363, 364, 365, 366, 367, 368, 369, 370, and 371 based on the position of the vehicle 10. Then, the processor 170 may continuously receive tiles and may delete the pre-received tiles while the vehicle 10 moves.

FIG. 6C is a diagram for explaining an operation of generating electronic horizon data according to an embodiment of the present disclosure.

Referring to FIG. 6C, the processor 170 may generate the electronic horizon data based on HD map data.

The vehicle 10 may travel in the state in which a final destination is set. The final destination may be set based on user input received through the user interface device 200 or the communication device 220. In some embodiments, the final destination may also be set by the travel system 260.

In the state in which the final destination is set, the vehicle 10 may be positioned within a preset distance from a first point while traveling. When the vehicle 10 is positioned within a preset distance from the first point, the processor 170 may generate electronic horizon data using a first point as a start point and a second point as an end point. Each of the first point and the second point may be one point on a path toward the final destination. The first point may be described as the point at which the vehicle 10 is currently positioned or is to be positioned in the near future. The second point may be described as the aforementioned horizon.

The processor 170 may receive an HD map of a region including a section to the second point from the first point. For example, the processor 170 may make a request for an HD map of a region within a predetermined radius from a section to the second point from the first point and may receive the HD map.

The processor 170 may generate electronic horizon data on a region including the section to the second point from the first point based on the HD map. The processor 170 may generate horizon map data of the region including the section to the second point from the first point. The processor 170 may generate horizon path data of the region including the section to the second point from the first point. The processor 170 may generate data on a main path 313 of the region including the section to the second point from the first point. The processor 170 may generate data on a sub path 314 of the region including the section to the second point from the first point.

When the vehicle 10 is positioned within a preset distance from the second point, the processor 170 may generate electronic horizon data using a second point as a start point and a third point as an end point. Each of the second point and the third point may be one point on a path toward a final destination. The second point may be described as a point at which the vehicle 10 is currently positioned or is to be positioned in the near future. The third point may be described as the aforementioned horizon. The electronic horizon data using the second point as a start point and the third point as an end point may be geographically connected to the aforementioned electronic horizon data using the first point as a start point and the second point as an end point.

The aforementioned operation of generating the electronic horizon data using the first point as a start point and the second point as an end point may be applied in the same way to the operation of generating the electronic horizon data using the second point as a start point and the third point as an end point.

In some embodiments, the vehicle 10 may also travel in the state in which a final destination is not set.

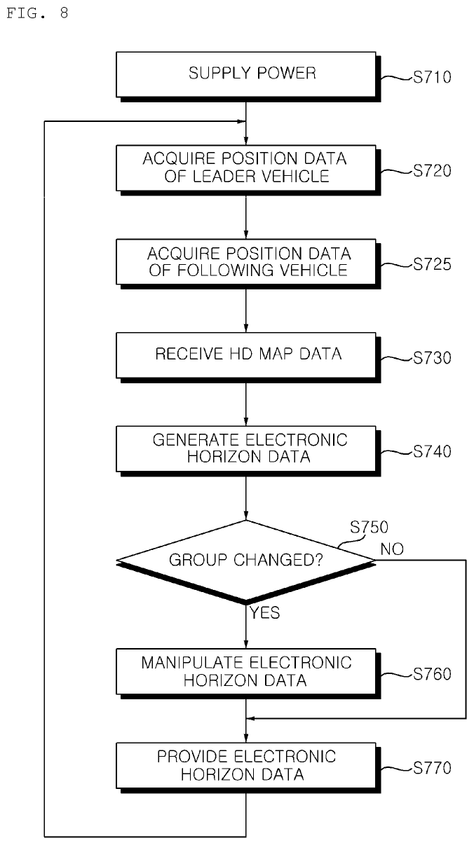

FIG. 7 is a diagram for explaining platooning according to an embodiment of the present disclosure.

The system 1 may include a group 700 and the infrastructure 20. The group 700 may include a leader vehicle 10a and following vehicles 10b, 10c, and 10d.

Referring to FIG. 7, the leader vehicle 10a and the following vehicles 10b, 10c, and 10d may travel while configuring the group 700. Data may be exchanged through communication between the leader vehicle 10a and the following vehicles 10b, 10c, and 10d. The leader vehicle 10a may transmit various data related to travel to the following vehicles 10b, 10c, and 10d. The following vehicles 10b, 10c, and 10d may follow the leader vehicle 10a while being spaced apart from one another by a predetermined interval. Any one of the following vehicles 10b, 10c, and 10d may deviate from the group 700. Other vehicles outside the group may be included in the group 700. The above description of the vehicle 10 may be applied in the same way to the leader vehicle 10a and the following vehicles 10b, 10c, and 10d. Although FIG. 7 illustrates an example in which three vehicles follow the leader vehicle 10a, the number of following vehicles is not limited thereto.

The leader vehicle 10a may include the electronic device 100. The description of the electronic device 100 described with reference to FIGS. 1 to 6C may be applied in the same way to the electronic device 100 of the leader vehicle 10a.

The electronic device 100 may include the power supply 190, the interface 180, the processor 170, and the memory 140. The power supply 190 may supply power. The interface 180 may receive HD map data of a specified region from the server 21 through the communication device 220. The processor 170 may continuously generate electronic horizon data of the specified region based on HD map data in the state in which power is received.

The processor 170 may receive an HD map tile based on a travel path of the leader vehicle 10a. The processor 170 may receive the HD map tile based on a sensing region and the point/path in which deviation is estimated of the plurality of vehicles 10a, 10b, 10c, and 10d configuring the group 700. For example, the processor 170 may receive even a related HD map tile in order to generate sub path data about a branch road on which the following vehicles 10b, 10c, and 10d travels after deviation from a group while travelling on an expressway.

The processor 170 may receive information on the position of each of the following vehicles 10b, 10c, and 10d from the following vehicles 10b, 10c, and 10d through the communication device 220 and the interface 180. The processor 170 may calculate a range of the group 700 based on information on the positions of the following vehicles 10b, 10c, and 10d of the plurality of vehicles 10a, 10b, 10c, and 10d. A range of the group 700 may be described as a geographic region occupied by the group 700. In addition, the range of the group 700 may be described as a total length to the last following vehicle 10d from the leader vehicle 10a in the state in which the plurality of vehicles 10a, 10b, 10c, and 10d configure a group.

The processor 170 may calculate the range of the group 700 based on the type and position information of each of the vehicles 10a, 10b, 10c, and 10d configuring the group 700, a sensor recognition range of each of the vehicles 10a, 10b, 10c, and 10d, or the like.

The processor 170 may generate electronic horizon data for platooning based on the range of the group. The processor 170 may select a path, a road, and a lane which are appropriate for the size of the group and may generate horizon path data. The processor 170 may generate a main path and a sub path for platooning.

The processor 170 may provide the electronic horizon data to the following vehicles 10b, 10c, and 10d through the interface 190 and the communication device 220. In this case, platooning may be performed even in a communication disabled state.

When the size of the entire group 700 is not maintained due to the characteristics of a road, the group 700 may be divided. The processor 170 may provide information on the point of a leader vehicle (sub leader vehicle) of the divided group deviates from the group, an HD map tile, entire horizon path data, the point at which the leader vehicle joins the group, and the like.

When a vehicle deviates from the group 700, the processor 170 may transmit sensing information that is being processed by the corresponding vehicle and electronic horizon data that is distributed-processed to allow a vehicle with the lowest computing power consumption to process the transmitted data.

When a new vehicle joins the group 700, the processor 170 may download the HD map tile and may change a sensing region based on a range of the group 700.

When the group is divided into two groups, it may be possible to distinguish between a data sensing group and an HD map data reception group. For example, a leader group may be distinguished as the sensing group and a following group may be distinguished as the HD map data reception group. When the divided groups are combined again, one HD map data may be generated by combining HD map data of the respective groups.

When platooning arrangement is changed, HD map data and a vehicle to be sensed may be selected again depending on rearrangement.

When a travel road is smaller than the size of the group 700, the electronic device 100 may attempt to divide the group 700. To divide the group 700, the processor 170 may transmit a signal to at least one of the following vehicles 10b, 10c, and 10d. The processor 170 may set any one of the following vehicles 10b, 10c, and 10d to the sub leader vehicle and may transmit a signal of a command for dividing the group 700. In this case, to divide the group 700, the processor 170 may transmit HD map data and electronic horizon data to at least one of the following vehicles 10b, 10c, and 10d. The electronic horizon data may include information on the point at which the group 700 is divided and information on the point at which a vehicle joins the group. In this case, the sub leader vehicle 10c may manipulate the electronic horizon data to the point at which the vehicle joins the group from the point at which the group 700 is divided, based on the received HD map data. In this case, the sub leader vehicle 10c and the vehicle 10d that follows the sub leader vehicle 10c may deviate from the point at which the vehicle deviates from the group, may travel on a different path from the leader vehicle 10a, and may join the point at which the vehicle joins the group again.

The processor 170 may transmit a signal for requesting electronic horizon data to a first following vehicle based on computing power. The computing power may be interpreted as including the data processing speed, data processing amount, and data storage amount of the processor 170. When determining that computing power is insufficient, the processor 170 may transmit the signal for requesting the electronic horizon data to a first following vehicle 10b. The first following vehicle 10b may be a vehicle having the lowest computing power consumption among the plurality of following vehicles 10b, 10c, and 10d. The first following vehicle 10b may generate the electronic horizon data instead of the leader vehicle 10a.

When determining that the first following vehicle 10b deviates from the group 700, the processor 170 may transmit the signal for requesting electronic horizon data to a second following vehicle 10c having the lowest computing power consumption among vehicles of the group 700. The second following vehicle 10c may generate the electronic horizon data instead of the leader vehicle 10a.

When determining that the arrangement of the group 700 is changed, the processor 170 may calculate a range of the changed group and may process electronic horizon data based on the range of the changed group. For example, any one of the following vehicles 10b, 10c, and 10d may deviate from the group and the arrangement of the group 700 may be changed. For example, other vehicles other than the group 700 may join the group and the arrangement of the group 700 may be changed. For example, the arrangement of the group 700 may be changed by changing the relative positions of the vehicles 10a, 10b, 10c, and 10d or the arrangement thereof inside the group 700. In this case, the processor 170 may calculate the range of the changed group based on position data of each of the vehicles 10a, 10b, 10c, and 10d configuring the group 700.

The processor 170 may generate main path data with respect to a road on which the group 700 is capable of traveling as a target based on the range of the group 700. The processor 170 may generate main path data with respect to the road on which the vehicle is capable of traveling, based on the whole length and width of the group 700. For example, the processor 170 may set a safe entrance path at a branch point of an expressway ramp in consideration of the length and width of the group 700.

The processor 170 may generate main path data with respect to a road on which the group 700 is capable of traveling, based on the range of the group 700.

The processor 170 may variably delete the main path data based on information on the position of the last following vehicle 10d. For example, the processor 170 may delete main path data corresponding to a longer distance than a specified distance backward from the position of the last following vehicle 10d. In general, the past path may remain by only a predetermined distance and may be sequentially deleted, but in the case of platooning, the past path may be deleted in consideration of even the position of the last following vehicle.

The processor 170 may determine a sensing region required to generate a horizon path based on information on the leader vehicle 10a and information on the following vehicles 10b, 10c, and 10d. For example, the processor 170 may determine front and lateral sides of the leader vehicle 10a as a sensing region required to generate the horizon path and may determine a rear side of the leader vehicle 10a as a sensing region that is not required to generate the horizon path. For example, the processor 170 may determine a lateral side of the first following vehicle 10b and the second following vehicle 10c as the sensing region required to generate the horizon path and may determine front and rear sides of the first following vehicle 10b and the second following vehicle 10c as the sensing region that is not required to generate the horizon path. The processor 170 may determine lateral and rear sides of the third following vehicle 10d as the sensing region required to generate the horizon path and may determine a front side of the third following vehicle 10d as the sensing region that is not required to generate the horizon path.

The processor 170 may receive information on a destination of the following vehicles 10b, 10c, and 10d. The processor 170 may generate sub path data of a branch road on which the following vehicles 10b, 10c, and 10d deviate from the group 700, based on the information on the destination of the following vehicles 10b, 10c, and 10d. When any one of the following vehicles 10b, 10c, and 10d deviates from the group 700, sub path data may be used.

The processor 170 may acquire information on a traffic light from the infrastructure 20. The processor 170 may manipulate electronic horizon data based on the information on the traffic light and information on the group 700. The information on the group 700 may include information on the length of the group 700 and information on a speed at which the group 700 moves. The information on the traffic light may include information on the position of the traffic light and information on the time at which a signal is changed. When the group 700 is supposed to pass a section in which the traffic light is present, the electronic horizon data may be manipulated in such a way that the group 700 is not divided.

The processor 170 may generate electronic horizon data based on the characteristic of a lane. The processor 170 may generate the electronic horizon data in further consideration of information on a traveling speed for each lane, information on whether a current lane is a platooning lane, and information on a branch point. The processor 170 may generate the main path data in further consideration of the information on the traveling speed for each lane, the information on whether a current lane is a platooning lane, and the information on a branch point.

The processor 170 may information on travel of the group 700 as dynamic data. The processor 170 may provide information on real-time travel of the group 700 to the infrastructure 20. The infrastructure 20 may provide information on an approach region for joining the group 700 to other vehicles outside the group 700. The infrastructure 20 may provide traffic occurrence information of a lane on which the group 700 travels to other vehicles outside the group 700. The infrastructure 20 may provide information on a road/lane and information on the time at which the group passes, which are difficult to temporarily use due to travel of the group 700, to other vehicles except for the group 700.

The following vehicles 10b, 10c, and 10d may include the electronic device 100. The description of the electronic device 100 described with reference to FIGS. 1 to 6C may be applied in the same way to the electronic device 100 of the following vehicles 10b, 10c, and 10d. The electronic device 100 may include the power supply 190, the interface 180, the processor 170, and the memory 140. The power supply 190 may supply power. The interface 190 may receive HD map data of a specified region from the server 210 through the communication device 220. The processor 170 may continuously generate the electronic horizon data of a specified region based on HD map data in the state in which power is supplied.

The processor 170 may receive a signal for requesting data processing from the leader vehicle 10a among the plurality of vehicles 10a, 10b, 10c, and 10d. In this case, the processor 170 may generate electronic horizon data for platooning. The processor 170 may provide the electronic horizon data to the leader vehicle 10a. The processor 170 may provide the electronic horizon data to other following vehicles.

The system 1 may include the infrastructure 20, the leader vehicle 10a, and the following vehicles 10b, 10c, and 10d. The description of the infrastructure 20 described with reference to FIGS. 1 to 6C may be applied to the infrastructure 20. The following vehicles 10b, 10c, and 10d may be defined as a vehicle that follows the leader vehicle 10a while configuring a group with the leader vehicle 10a. The infrastructure 20 may communicate with the leader vehicle 10a and the following vehicles 10b, 10c, and 10d.

The infrastructure 20 may receive information on the group from at least one of the leader vehicle 10a or the following vehicles 10b, 10c, and 10d. The infrastructure 20 may generate electronic horizon data for platooning based on a range of the group. The infrastructure 20 may provide the electronic horizon data to the leader vehicle 10a.

The infrastructure 20 may receive information on a changed situation of the group 700 at least one of the leader vehicle 10a or the following vehicles 10b, 10c, and 10d. The infrastructure 20 may manipulate the electronic horizon data based on the information on the changed situation of the group 700. The changed situation of the group 700 may occur based on deviation of a vehicle from the group 700, joining of a vehicle, a change in a relative position between vehicles, or the like.

The leader vehicle 10a may backup the electronic horizon data. The leader vehicle 10a may receive the electronic horizon data from the infrastructure 20 and may store the same in the memory 140.

When the following vehicles 10b, 10c, and 10d deviate from the group 700, electronic horizon data may be generated based on HD map data.

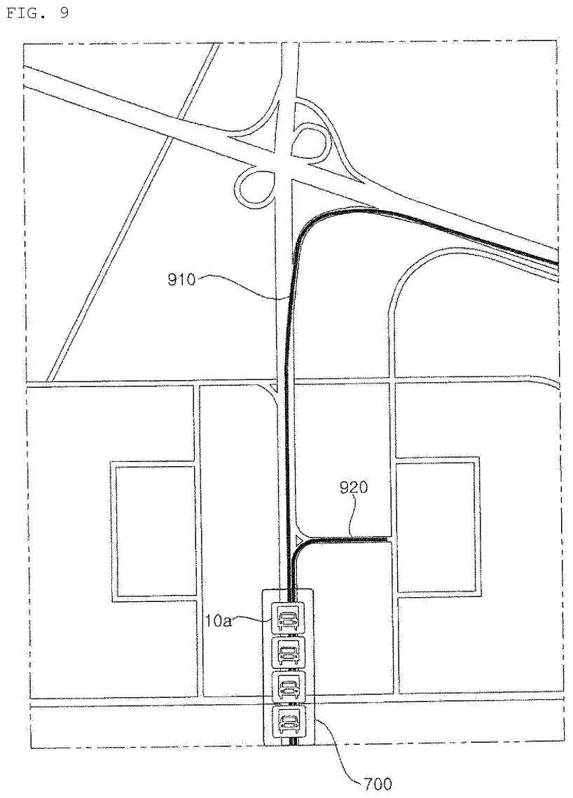

FIG. 8 is a flowchart of an electronic device according to an embodiment of the present disclosure.

Referring to FIG. 8, the processor 170 may receive power through the power supply 190 (S710). The power supply 190 may supply power to the processor 170. When the vehicle 10 is turned on, the processor 170 may receive power supplied from a battery included in the vehicle 10 through the power supply 190. When power is received, the processor 170 may perform a processing operation.

The processor 170 may acquire position data of the leader vehicle 10a (S720). The processor 170 may receive position data of the vehicle 10 by a predetermined interval from the position-data-generating-device 280 through the interface 180. The interface 180 may receive the position data of the vehicle 10 from the position-data-generating-device 280 in the state in which the vehicle 10 travels. The interface 180 may transmit the received data to the processor 170. The processor 170 may acquire the position data of the vehicle 10 in units of traveling lanes.

The processor 170 may acquire the position data of the following vehicles 10b, 10c, and 10d (S725). The communication device 220 may receive the position data of each of the following vehicles 10b, 10c, and 10d from the following vehicles 10b, 10c, and 10d. The processor 170 may receive the position data of each of the following vehicles 10b, 10c, and 10d from the communication device 220 through the interface 180.

The processor 170 may receive HD map data through the interface 180 (S730). The interface 180 may receive HD map data of a specified geographic region from the server 21 through the communication device 220 in the state in which the vehicle 10 travels. The interface 180 may receive the HD map data of the vicinity of the position of the vehicle 10. The interface 180 may transmit the received HD map data to the processor 170.

The processor 170 may continuously generate electronic horizon data of a specified region based on the HD map data in the state in which power is received (S740). The processor 170 may generate the electronic horizon data to a horizon from the position of the vehicle 10. The electronic horizon data may include horizon map data and horizon path data.

The processor 170 may calculate the range of the group 700 based on position information of the following vehicles 10b, 10c, and 10d among the plurality of vehicles 10a, 10b, 10c, and 10d. The processor 170 may generate the electronic horizon data for platooning based on the group of the group.

The processor 170 may determine whether the group is changed (S750). The group may be changed by deviation of a vehicle in the group, joining of other vehicles, or change in the position/arrangement of vehicles in the group.

When determining that the group is changed, the processor 170 may calculate the range of the changed group. The processor 170 may manipulate the electronic horizon data for platooning based on the range of the changed group (S760).

The processor 170 may provide the electronic horizon data to the travel system 260 through the interface 180 (S770). The processor 170 may provide electronic horizon data corresponding to the set geographic range to the travel system 260 through the interface 180. The processor 170 may provide the changed electronic horizon data with a message corresponding to event occurrence information. The processor 170 may provide the changed electronic horizon data to the travel system 260 and may provide the event occurrence information to the user interface device 200.

Then, the processor 170 may repeatedly perform operations subsequent to operation S720.

Operations S720 to S770 may be performed in the state in which power is received from the power supply 190.

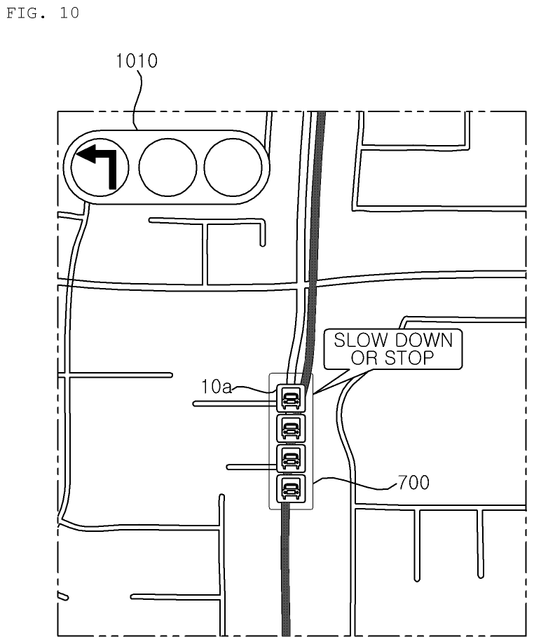

FIGS. 9 to 11B are diagrams for explaining an operation of an electronic device according to an embodiment of the present disclosure.

Referring to FIG. 9, when a plurality of vehicles travels while configuring the group 700, the electronic device 100 of the leader vehicle 10a may generate electronic horizon data for travel of the group 700.

When a vehicle travels alone, the electronic device 100 may form data about a horizon path 920 for reaching a destination using the shortest path, and in contrast, when vehicles travel to configuring the group 700, the electronic device 100 may select a road on which the group 700 is capable of traveling and may generate data about a horizon path 910. The electronic device 100 of the leader vehicle 10a may form a horizon path along which all vehicles configuring the group 700 are capable of safely traveling.

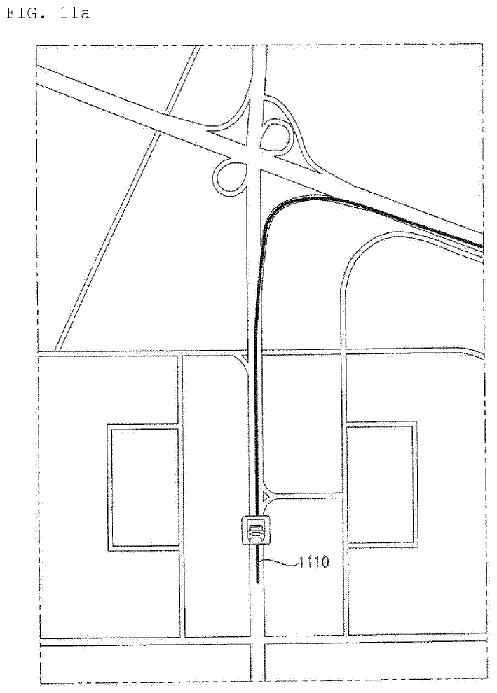

Referring to FIG. 10, the electronic device 100 of the leader vehicle 10a may information on a traffic light from the infrastructure 20. The electronic device 100 may manipulate the electronic horizon data based on information on a traffic light 1010 and information on the group 700. The information on the group 700 may include information on the length of the group 700 and information on a speed at which the group 700 moves. The information on the traffic light may include information on the position of the traffic light and information on the time at which a signal is changed.

For example, based on the time at which the traffic light 1010 is changed, the leader vehicle 10a may be capable of passing an intersection, but when the following vehicle is not capable of passing the intersection, electronic horizon data may be generated to lower a speed or stop the vehicle.

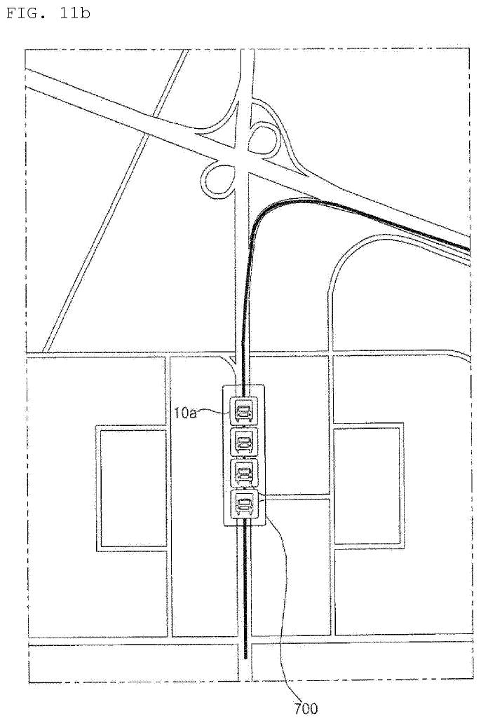

Referring to FIG. 11A, when the vehicle 10 travels alone, the electronic device 100 may delete data about a path that the vehicle 10 passes. The electronic device 100 may delete data except for data about only a horizon path 1110 corresponding to a preset length backward from the vehicle 10. For example, data except for only horizon path data corresponding to 100 m backward from the vehicle 10 may be deleted.

Referring to FIG. 11B, while a plurality of vehicles travels while configuring a group, the electronic device 100 of the leader vehicle 10a may delete main path data based on position information of the last following vehicle 10d. For example, the electronic device 100 may delete main path data corresponding to a longer distance than a specified distance backward from the position of the last following vehicle 10d, for other vehicles that are supposed to join the new group 700.

The aforementioned present disclosure can also be embodied as computer readable code stored on a computer readable recording medium. The computer readable recording medium is any data storage device that can store data which can thereafter be read by a computer. Examples of the computer readable recording medium include a hard disk drive (HDD), a solid state drive (SSD), a silicon disk drive (SDD), read-only memory (ROM), random-access memory (RAM), CD-ROM, magnetic tapes, floppy disks, optical data storage devices, carrier waves (e.g., transmission via the Internet), etc. The computer may include a processor or a controller. Accordingly, it is intended that the present disclosure cover the modifications and variations of this invention provided they come within the scope of the appended claims and their equivalents.

### DESCRIPTION OF REFERENCE NUMERAL

100: Vehicle

What is claimed:

1. An electronic device included in a leader vehicle among a plurality of platooning vehicles, comprising:
a power supply configured to supply power;
an interface configured to receive high-definition (HD) map data of a specified region from a server through a communication device; and
a processor configured to continuously generate electronic horizon data of the specified region based on the HD map data in a state in which the power is received, to calculate a range of a group based on information on a position of a following vehicle among the plurality of vehicles, and to generate electronic horizon data for platooning based on the range of the group.

2. The electronic device of claim 1, wherein the processor transmits the HD map data and the electronic horizon data to at least one of following vehicles, for dividing the group; and
wherein the electronic horizon data comprises information on a point at which the group is divided and information on a point at which a vehicle joins the group.

3. The electronic device of claim 1, wherein the processor transmits a signal for requesting electronic horizon data to a first following vehicle based on computing power.

4. The electronic device of claim 3, wherein, when determining that the first following vehicle deviates from the group, the processor transmits a signal for requesting electronic horizon data to a second following vehicle having a lowest power consumption among vehicles of the group.

5. The electronic device of claim 1, wherein, when determining that arrangement of the group is changed, the processor calculates a range of the changed group, and manipulates the electronic horizon data based on the range of the changed group.

6. The electronic device of claim 1, wherein the processor generates main path data with respect to a road on which the group is capable of passing as a target, based on the range of the group.

7. The electronic device of claim 6, wherein the processor deletes the main path data based on information on a position of a last following vehicle.

8. The electronic device of claim 1, wherein the processor determines a sensing region required to generate a horizon path based on information on the leader vehicle and information on the following vehicle.

9. The electronic device of claim 1, wherein the processor receives information on a destination of the following vehicle, and generates sub path data of a branch road at which the following vehicle deviates from the group based on the information on the destination.

10. The electronic device of claim 1, wherein the processor acquires information on a traffic light, and manipulates the electronic horizon data based on the information on the traffic light and information on the group.

11. The electronic device of claim 1, wherein the processor generates electronic horizon data in further consideration of information on a traveling speed for each lane, information on whether a current lane is a platooning lane, and information on a branch point.

12. An electronic device included in a leader vehicle among a plurality of platooning vehicles, comprising:
a power supply configured to supply power;
an interface configured to receive high-definition (HD) map data of a specified region from a server through a communication device; and
a processor configured to continuously generate electronic horizon data of the specified region based on the HD map data in a state in which the power is received, and to generate electronic horizon data for platooning and to provide the electronic horizon data to the leader vehicle when receiving a signal for requesting data processing from a leader vehicle among the plurality of vehicles.

13. A system comprising:
a leader vehicle;
at least one following vehicle configured to follow the leader vehicle while configuring a group with the leader vehicle; and
an infrastructure configured to communicate with the leader vehicle and the following vehicle,
wherein the infrastructure receives information on a range of a group from at least one of the leader vehicle or the following vehicle, generates electronic horizon data for platooning based on the range of the group, and provides the electronic horizon data to the leader vehicle.

14. The system of claim 13, wherein the infrastructure receives information on a changed situation of the group from at least one of the leader vehicle or the following vehicle, and manipulates the electronic horizon data based on the information on the changed situation of the group.

15. The system of claim 13, wherein the leader vehicle backups the electronic horizon data.

16. The system of claim 13, wherein, when deviating from the group, the following vehicle generates electronic horizon data based on high-definition (HD) map data.
